(19) United States
(12) Patent Application Publication
(10) Pub. No.: US 2015/0143481 A1
(43) Pub. Date: May 21, 2015

(54) APPLICATION SECURITY VERIFICATION METHOD, APPLICATION SERVER, APPLICATION CLIENT AND SYSTEM

(71) Applicant: Tencent Technology (Shenzhen) Co., Ltd., Shenzhen (CN)

(72) Inventors: Ming Chen, Shenzhen (CN); Wei Shi, Shenzhen (CN); Zhigang Song, Shenzhen (CN); Maocai Li, Shenzhen (CN)

(21) Appl. No.: 14/590,561

(22) Filed: Jan. 6, 2015

Related U.S. Application Data
(63) Continuation of application No. PCT/CN2014/078466, filed on May 27, 2014.

(30) Foreign Application Priority Data
Nov. 15, 2013 (CN) 2013105740686

(51) Int. Cl. H04L 29/06

(52) U.S. Cl. CPC H04L 63/12
USPC 726/5

(57) ABSTRACT

The disclosure discloses an application security verification method, an application server, an application client, and a system, wherein the application security verification method includes: detecting by an application server, an occurrence of a default security risk event on an application client; obtaining by the application server, default verification information associated with a login account of the application client; and sending by the application server, the default verification information to the application client in order to verify the application client. A user of an application client may therefore verify the security of the application client and the application server, thereby effectively prevents any forged and illegal APP from threatening the security of the user's private information and financial information.

### CROSS-REFERENCE TO RELATED APPLICATIONS

The application is a continuation of PCT Application No. PCT/CN2014/078466, filed on May 27, 2014, which claims priority to Chinese Patent Application No. 2013105740686, filed on Nov. 15, 2013, which is incorporated by reference in its entireties.

### FIELD OF THE TECHNOLOGY

The present disclosure relates to the field of Internet, and more particularly to an application security verification method, application server, application client and system.

### BACKGROUND

As with the continued development of the mobile Internet and e-commerce, users come across forged applications more often. Such illegal applications may disguise under an appearance which imitates a legal or legitimate entity using a technique commonly known as phishing in order to trick the user to enter user's private information in an alleged verification process. Such security breaches have posed enormous threats to the users' personal accounts and heavy financial damages to users and financial institutions every year. There is however, no known effective method available to enable a user to quickly perform effective security verification on an application client which is being used to perform a transaction.

### SUMMARY

The embodiments of the present disclosure provide an application security verification method, application server, application client, and system which may allow a user of an application client to verify the security of the application client and the application server.

The following disclosures solve the above-mentioned technical problems. In a first aspect of an embodiment, an application security verification method is disclosed, which may include at least the operations of: detecting by an application server, an occurrence of a default security risk event on an application client; obtaining by the application server, default verification information associated with a login account of the application client; and sending by the application server, the default verification information to the application client in order to verify the application client.

In a second aspect of the disclosure, there discloses an application security verification method, which includes the operations of: receiving by an application client, a prompt message sent by an application server, wherein the prompt message is used to prompt a user of the application client to input default verification information; sending by the application client to the application server, the default verification information input by the user in response to the prompt message, such that the application server storing the default verification information in association with the login account of the application client; and upon the application server detecting the occurrence of a default security risk event on the application client, the application client receiving from the application server the default verification information associated with the login account of the application client in order to verify the application client.

In a third aspect of the disclosure, there discloses a non-transitory computer readable storage medium, wherein the computer readable storage medium stores a program which comprises codes or instructions to cause a machine to execute application security verification operations, the operations may include: detecting by an application server, an occurrence of a default security risk event on an application client; obtaining by the application server, default verification information associated with a login account of the application client; and sending by the application server, the default verification information to the application client in order to verify the application client.

In a fourth aspect of the disclosure, there discloses a non-transitory computer readable storage medium, wherein the computer readable storage medium stores a program which comprises codes or instructions to cause a machine to execute application security verification operations, the operations may include: receiving by an application client, a prompt message sent by an application server, wherein the prompt message is used to prompt a user of the application client to input default verification information; sending by the application client to the application server, the default verification information input by the user in response to the prompt message, such that the application server storing the default verification information in association with the login account of the application client; and upon the application server detecting the occurrence of a default security risk event on the application client, the application client receiving from the application server the default verification information associated with the login account of the application client in order to verify the application client.

In a fifth aspect of the disclosure, there discloses an application server, wherein the application server comprises at least a processor operating in conjunction with at least a memory which stores instruction codes operable as plurality of units, wherein the plurality of units may include: a security event detection unit which detects an occurrence of a default security risk event on an application client; a verification information acquisition unit, which obtains default verification information associated with the login account of the application client when the security event detection unit detects an occurrence of a default security risk event on the application client; and a sending unit, which sends the default verification information to the application client in order to verify the application client.

In a sixth aspect of the disclosure, there discloses an application client, comprises at least a processor operating in conjunction with at least a memory which stores instruction codes operable as plurality of units, wherein the plurality of units which may include: a receiving unit, which receives a prompt message sent by an application server, wherein the prompt message is used to prompt a user of the application client to input the default verification information; a sending unit, which sends to the application server the default verification information which is input by the user in response to the prompt message, such that the application server stores the default verification information which is associated with the login account of the application client; and the sending unit further receives from the application server, the default verification information associated with the login account of the application client to verify the application client when the application server detects an occurrence of a default security risk event on the application client.

In a seventh aspect of the disclosure, there discloses an application security verification system, wherein the application security verification system comprises at least an application client and an application server, wherein: the application server sends a prompt message to the application client, wherein the prompt message is used to prompt a user of the application client to input default verification information; the application client receives a prompt message sent by an application server and sends to the application server the default verification information input by a user in response to the prompt message; wherein the application server receives the default verification information sent by the application client and store the default verification information which is associated with the login account of the application client; the application server further detects an occurrence of a default security risk event on the application client, obtains the default verification information associated with the login account of the application client and sends the default verification information to the application client; and wherein the application client receives the default verification information sent by the application server, wherein the default verification information is used to verify the application client.

In the embodiments of the present disclosure, the application server, on detecting an occurrence of a security risk event on the application client, sends to the application client default verification information associated with a login account of the application client. In this way, the user of the application client may verify the security of both of the application client and the application server, thereby effectively preventing any forged and illegal application from threatening the security of the user's private information and financial information.

To put differently, the embodiments described enable the user to prevent a “forged application client” from posing as a legitimate source to “phish” user's private information through the user taking a proactive action to “quiz” or “verify” the application client (which may pose as an alleged bank website or an alleged bank email notification to the user) through one or more default verification information (i.e., questions, passwords, voice, picture, video clip) which has previously been set up by the user and stored in the application server for verification purposes.

### BRIEF DESCRIPTION OF THE DRAWINGS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, but not to limit the present disclosure.

FIG. 1 illustrates a flowchart of an exemplary application security verification method, according to an embodiment of the present disclosure.

FIG. 2 illustrates an interactive process of an application security verification method, according to an embodiment of the present disclosure.

FIG. 3 depicts a terminal receiving a prompt message delivered by an application server which is displayed on an application client, according to an embodiment of the present disclosure.

FIG. 4 illustrates an exemplary block diagram of an application server, according to an embodiment of the present disclosure.

FIG. 5 illustrates an exemplary block diagram of an application server, according to an embodiment of the present disclosure.

FIG. 6 illustrates an exemplary block of an application client, according to an embodiment of the present disclosure.

FIG. 7 illustrates an exemplary block of a user terminal on which the application client is installed, according to an embodiment of the present disclosure.

FIG. 8 illustrates an exemplary application security verification system, according to an embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, but not to limit the present disclosure.

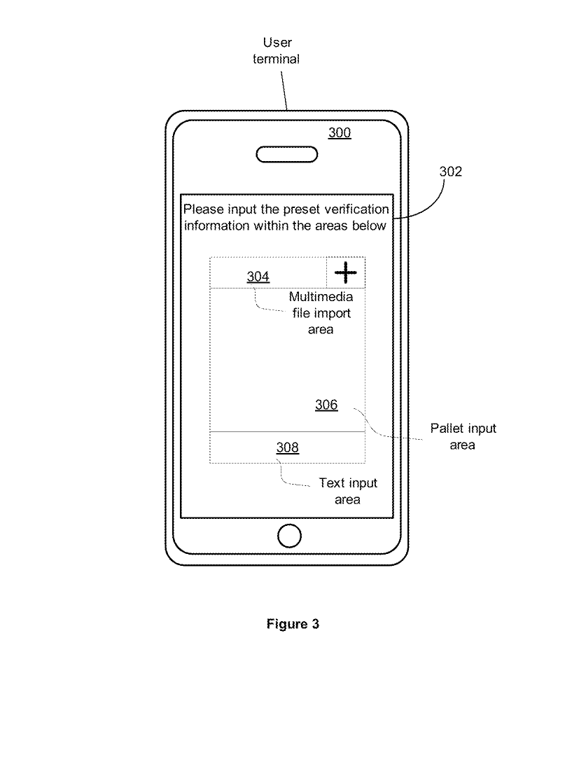

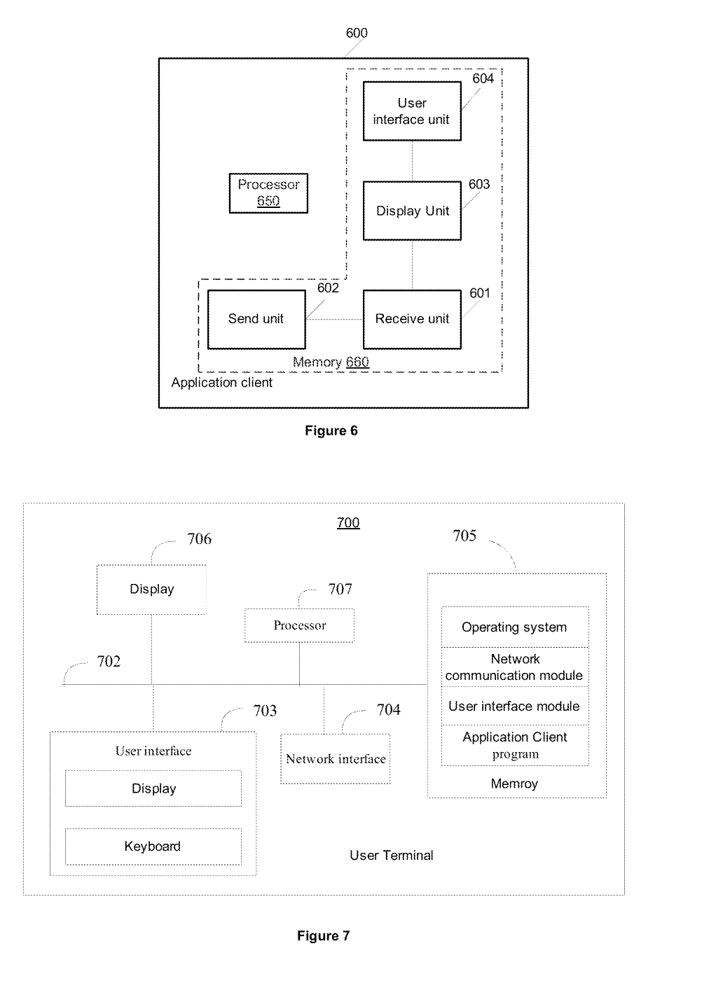

An application client (as shown in FIG. 6) described in an embodiment of the present disclosure may be an application software process running on a user terminal (as shown in FIGS. 3 and 7). For example, an application client may be an instant communication (SMS) client, a social networking services (SNS) client, and an Internet payment client, to name a few. The application client may log in to a corresponding server utilizing a login account input by the user. The user terminal may be an Internet connection device such as a PC, a smartphone, for example, an Android-based mobile phone and iOS-based mobile phone, a tablet PC, a Personal Digital Assistant (PDA), a Mobile Internet Device (MID), and any wearable smart device that connects to a network.

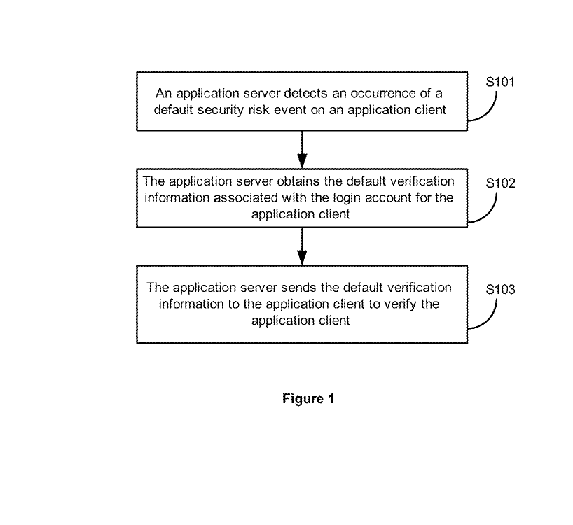

FIG. 1 illustrates a flowchart of an exemplary application security verification method, according to an embodiment of the present disclosure. The application security verification method may include at least the following exemplary operations:

S101: An application server detects the occurrence of a default security risk event on an application client. In actual implementation, a series of events that may threaten the security of a user's account or private information may by default be treated as security risk events on the application server.

The security risk events may include a login event, a payment event, and a verification information modification event. For example, an application client may send a login request to an application server. After verifying the login request submitted by the application client, the application server may allow a pass to the login of the application client which constitutes a login event having occurred. Alternately, when an application client sends an online payment request to an application server, the application server may detect an occurrence of a payment event on the application client. In this case, the application server may determine that it needs to further notify the user of the existing security status so that the user may feel secured to proceed to a next operation. The next operations may implement the following subsequent steps in the application security verification.

S102: The application server obtains the default verification information associated with the login account of the application client. In actual implementation, a user may use the application client to submit default verification information to an application server beforehand. The application server may store the default verification information previously submitted by the application client, which default verification information is associated to the login account of the application client.

Thus, when the occurrence of a default security risk event on the application client is detected through S101, the default verification information previously submitted by the application client may be obtained by the application server utilizing the login account of the application client on which the security risk event occurs.

The default verification information may be in multimedia format, which includes text information, image information, audio information, video information or a combination of any of the above. If in text format, a text string consisting of various kinds of text, symbols or characters may be used. If in image format, the image may be the images submitted by the user, which may be image files in the *.jpg, *.png, and *.bmp formats. Image format may also include sketch images which a user may input on a pallet provided by the terminal on which the application client is installed. In addition, the image may be one or more photos taken by the user in real time by invoking a camera of the terminal. If in audio format, the audio file submitted by the user may be in a *.wav, *.amr, or *.mp3 format. If in video format, the video file submitted by the user may be in a *.3gp, *.mpeg, or *.avi format.

Preferably, upon ensuring that the application client currently being used may be secured and authentic, the user may submit the default verification information to the application server. For example, an application client may be considered to be secured if downloaded from an official website of the application. In an optional embodiment, the user may also submit the default verification information by using the official website of the application.

S103: The application server may send the default verification information to the application client to verify the application client. In actual implementation, upon receiving the default verification information sent by the application server, the application client may display the default verification information for the user's review. For example, the text information or image information contained in the default verification information may be displayed in a verification information prompt dialog box on the user's terminal, and a corresponding player may be invoked the to play the audio information or video information contained in the default verification information.

Accordingly, the user may determine whether the current application client is from a secured or trusted source through checking whether the received default verification information is the received default verification information submitted previously to the application server. In case if the security risk event that occurs on the application client has failed to receive the default verification information delivered by the application server, or the default verification information delivered is not the same as those submitted by the user beforehand, the current application client may be determined to be a forged and illegal application from an illegitimate source. In such a case, the user may stop using the application, thus preventing any further security threat or potential damages.

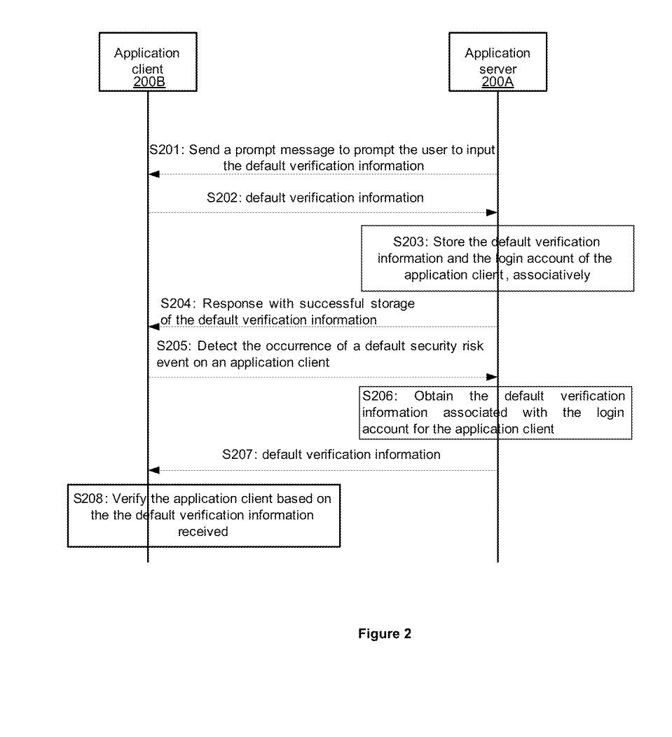

FIG. 2 illustrates an interactive process of an application security verification method, according to an embodiment of the present disclosure. The method may include at least the following exemplary operations:

S201: The application server (200A) may send a prompt message to the application client (200B), wherein the prompt message may prompt a user of the application client (200B) to input the default verification information. In actual implementation, the application server may send the prompt message to an application client at any time after the application client logs in to the application server successfully or simply send the prompt message to the application server without being asked. Alternately, the application client (200B), through an interface with the required function, may send a request asking for a submission of the default verification information to the application server (200A), and the application server then sends the prompt message to the application client.

S202: The application client (200B) may send to the application server (200A) the default verification information input by the user in response to the received prompt message. In actual implementation, after receiving the prompt message sent by the application server, the application client may display the prompt message and, depending on an input mode selected by the application client, obtaining by the application client the default verification information input by the user utilizing a corresponding user interface provided by the terminal on which the application client is installed, wherein the input mode comprises an input via anyone of the following: text character, sketching pad, voice, image, pictures or video.

As shown in FIG. 3, a user may input the default verification information (302) on the displayed prompt interface (306). For example, text information may be input in the text information input area (308), inputting sketch images in the pallet input area (306), clicking the “+” button on the right of the multimedia file import area (304) to import a default multimedia file to a storage medium of the terminal (300), and invoking the camera module of the terminal and sending the pictures taken or videos recorded in real time to the application server (200A).

S203: The application server (200A) may store the default verification information which is associated with the login account of the application client (200A).

S204: The application server (200A) returns to the application client (200B) a response of storing the default verification information to notify successful storage of the default verification information submitted by the user.

S205: The application server (200A) may detect the occurrence of a default security risk event on an application client (200B). In actual implementation, a series of events which may threaten the security of a user's account or private information may be considered as default security risk events on the application server. The security risk events may include anyone of: a login event, a payment event, and a verification information modification event.

For example, an application client may send a login request to an application server. After verifying the login request submitted by the application client, the server (200A) may grant a pass to the login of the application client (200B). In this case, a login event may take place. Alternately, when an application client sends an online payment request to an application server, the application server may detect the occurrence of a payment event on the application client. In this case, the application server may judge that it needs to notify the user of the existing security status so that the user feels secure to proceed with a next operation, which may then implement the subsequent steps of application security verification.

S206: The application server (200A) may obtain the default verification information associated with the login account of the application client.

S207: The application server (200A) may send the default verification information to the application client (200B).

S208: The application client may verify the application client based on the received default verification information. In actual implementation, upon receiving the default verification information sent by the application server (200A), the application client (200B) may display the default verification information for the user.

For example, the text information or image information contained in the default verification information may be displayed in a verification information prompt dialog box (see FIG. 3, elements 302-308) and invoking the corresponding player to play the audio information or video information contained in the default verification information.

Accordingly, the user may determine whether the current application client (200B) may be secured after checking whether the received default verification information would be the same as the received default verification information submitted in advance to the application server. If the security risk event that occurs on the application client fails to receive the default verification information sent by the application server or the default verification information delivered to the current application client is not the same as those previously submitted by the user, the current application client may be considered as forged and would have come from an illegitimate source. In such a case, the user may stop using the current application client, thereby preventing any further security threats.

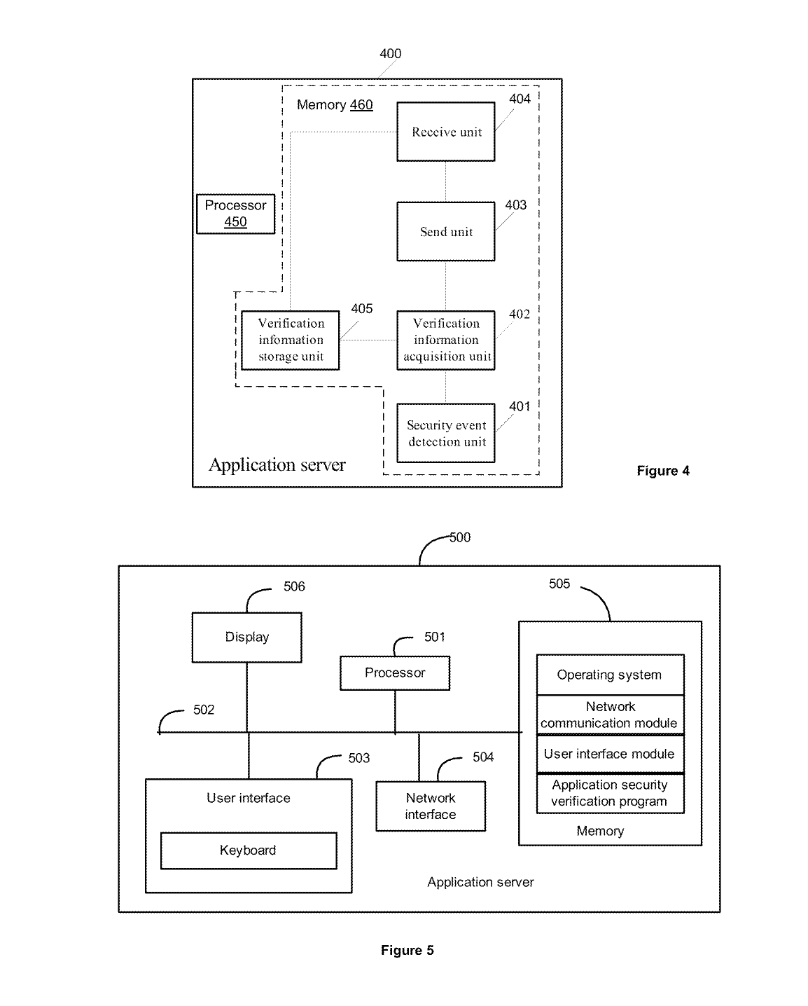

FIG. 4 illustrates an exemplary block diagram of an application server, according to an embodiment of the present disclosure. As shown in FIG. 4, the application server may include at least: a processor (450) operating in conjunction with at least a memory (460) which stores instruction codes operable as plurality of units, wherein the plurality of units may include at least a security event detection unit (401), a verification information acquisition unit (402) and a sending unit (403).

The security event detection unit (401) may detect an occurrence of a default security risk event on an application client. In actual implementation, a series of events that may threaten the security of a user's account or private information may be default as security risk events on the application server. The security risk events may include a login event, a payment event, and a verification information modification event.

For example, an application client may send a login request to an application server. After verifying the login request submitted by the application client, the server may permit a pass to the login of the client. In this case, the security event detection unit (401) may detect the occurrence of a login event on the application client. Alternately, when the application client sends an online payment request to the application server, the security event detection unit (401) may detect the occurrence of a payment event on the application client.

The verification information acquisition unit (402) may obtain default verification information associated with the login account of the application client when the security event detection unit detects an occurrence of a default security risk event on the application client. In actual implementation, a user may use the application client to submit default verification information to the application server beforehand. The application server may store the default verification information submitted by the application client wherein the default verification information is associated with the login account of the application client. Thus, when the security event detection unit (401) detects the occurrence of a default security risk event on the application client, the verification information acquisition unit (402) may obtain the default verification information submitted by the application client by using the login account of the application client on which the security risk event occurs.

The default verification information may be in multimedia format, which includes text information, image information, audio information, video information or a combination of any of the above. If in text format, a text string consisting of various kinds of text, symbols or characters may be used. If in image format, the image may be the images submitted by the user, which may be image files in the *.jpg, *.png, and *.bmp formats. Image format may also include sketch images which a user may input on a pallet provided by the terminal on which the application client is installed. In addition, the image may be one or more photos taken by the user in real time by invoking a camera of the terminal. If in audio format, the audio file submitted by the user may be in a *.wav, *.amr, or *.mp3 format. If in video format, the video file submitted by the user may be in a *.3gp, *.mpeg, or *.avi format.

Preferably, after ensuring that the application client currently used is secured and authentic, the user may submit the default verification information to the application server. For example, an authentic application client may be an application client which may be downloaded from the official website of the application. In an optional embodiment, the user may also submit the default verification information by using the official website of the application.

The sending unit (403) may send the default verification information to the application client in order to verify the application client. In actual implementation, upon receiving the default verification information sent by the application server, the application client may display the default verification information for the user. More specifically the text information or image information contained in the default verification information may be displayed in a verification information prompt dialog box and invoking the corresponding player to play the audio information or video information contained in the default verification information.

Accordingly, the user may determine whether the current application client is secure by checking whether the received default verification information is the received default verification information that have been submitted previously to the application server. If the security risk event that occurs on the application client fails to receive the default verification information sent by the application server or the default verification information sent is not the same as that submitted by the user previously, the current application client may be considered as a forged and illegal application client. In such a case, the user may stop using the application, thereby preventing any further security threat.

In an optional embodiment, the sending unit (403) may further send a prompt message to the application client, wherein the prompt message is used to prompt the user of the application client to input the default verification information;

The application server (400) may further include: a receiving unit (404) which receives the default verification information that is sent by the application client in response to the prompt message, a verification information storage unit (405) which may store the default verification information which is associated with the login account of the application client.

FIG. 5 illustrates an exemplary block diagram of an application server, according to an embodiment of the present disclosure. The application server (500) may include at least one processor (501), such as a CPU, at least one network interface (504), a user interface (503), a memory (505), at least one communication bus (502), and a display (506).

The communication bus (502) may be used to complete a connection and communication among the above-mentioned components. The user interface (503) may include a touch display and keyboard. Optionally, the user interface (503) may also include a standard wired interface and wireless interface. The network interface (504) optionally may include a standard wired interface and wireless interface, for example, a WIFI interface. The memory (505) may be a high-speed random access memory (RAM) or nonvolatile memory, for example, at least one disk storage module. The memory (505) optionally may also be a storage device far away from the processor (501). As shown in FIG. 5, the memory (505) may be a computer storage medium, which stores an operating system, a network communication module, a user interface module, and an application security verification program.

The network interface (504) may mainly be used to complete data communication with an application client. The processor (501) may be used to invoke the application security verification program stored in the memory (505) to execute the following operations: detecting an occurrence of a default security risk event on the application client by using the network interface (504); obtaining the default verification information that is associated with the login account of the application client and stored in the memory (505); and sending the default verification information by using the network interface (504) to the application client to verify the application client.

In an embodiment, the processor (501) may invoke the application security verification program stored in the memory (505), and the following operations may further be executed: sending a prompt message to the application client by using the network interface (504), wherein the prompt message may prompt the user of the application client to input the default verification information.

The network interface (504) may receive the default verification information sent by the application client in response to the prompt message; and the network interface (504) may store the default verification information which is associated with the login account of the application client in the memory (505).

FIG. 6 illustrates an exemplary block of an application client, according to an embodiment of the present disclosure. The application client may include at least a processor (650) operating in conjunction with at least a memory (660) which stores instruction codes operable as plurality of units, wherein the plurality of units include at least: a receive unit (601), a send unit (602), a display unit (603), a user interface unit (604).

The receiving unit (601) may receive a prompt message sent by an application server, wherein the prompt message is used to prompt a user of the application client to input default verification information. In actual implementation, the application server may send the prompt message to the application client at any time after the application client successfully logs in to the application server or send the prompt message to the application server without being asked. Alternately, the application client, through an interface with the required function, sends a request asking for submission of the default verification information to the application server and then the application server sends the prompt message to the application client.

The sending unit (602) may send to the application server the default verification information that a user inputs in response to the received prompt message, in order that the application server may stores the default verification information which is associated with the login account of the application client. In actual implementation, after receiving a prompt message sent by the application server, the application client may display the prompt message and, based on the user-selected input mode, obtain the user-input default verification information by invoking the corresponding user interface provided by the terminal on which the application client is installed. The input mode may be a text or character input, input using a pallet, voice input, image import, taken pictures, or video import.

The sending unit (601) may further receive, when the application server may detect an occurrence of a default security risk event on the application client and may verify the application client. The default verification information is associated with the login account of the application client. In actual implementation, a series of events that may threaten the security of a user's account or private information may be considered as default security risk events on the application server.

The security risk events may include a login event, a payment event, and a verification information modification event. For example, the application client may send a login request to the application server. After verifying the login request submitted by the application client, the server may permit the login of the client. In this case, a login event occurs. Alternately, when the application client sends an online payment request to the application server, the application server detects the occurrence of a payment event on the application client.

In this case, the application server may determine that the user may need to be notified of an existing security status, and sends to the application client the default verification information associated with the login account of the application client. Upon receiving the default verification information sent by the application server, the application client may display the default verification information on the user's terminal, such as displaying the text information or image information contained in the default verification information in a verification information prompt dialog box and invoking the corresponding player to play the audio information or video information contained in the default verification information.

Accordingly, the user may determine whether the current application client is secure by checking whether the received default verification information is the received default verification information submitted previously to the application server. If the security risk event that occurs on the application client fails to receive the default verification information delivered by the application server or the default verification information delivered is not the same as that submitted by the user previously, then the current application client may be a forged and illegal application client. In such a case, the user may stop using the application, thereby preventing any further security threat.

In an optional embodiment, an application client may further include: a display unit (603) which displays the prompt message, a user interface unit (604) which obtains, depending on an input mode selected by the application client, obtains the user-input default verification information utilizing a corresponding user interface provided by the terminal on which the application client is installed, wherein the input mode includes an input via anyone of the following: text character, sketching pad, voice, image, pictures or video.

The input mode may be a text input, a pallet input, a voice input, an image import, capturing pictures, or video import. As shown in FIG. 3, a user may input the default verification information on the displayed prompt interface, such as inputting text information in the text information input are (308) a, inputting sketch images in the pallet input area (306), clicking the “+” button on the right of the multimedia file import area to import a default multimedia file to the storage medium of the terminal (300), and invoking the camera module of the terminal and sending the pictures taken or videos recorded in real time to the application server.

FIG. 7 illustrates an exemplary block of a user terminal on which the application client is installed, according to an embodiment of the present disclosure. The user terminal may be an Internet device such as a PC, a smartphone, such as an Android-based mobile phone and iOS-based mobile phone, a tablet PC, a PDA, a MID, and any wearable smart device.

The user terminal (700) may include: at least one processor (701), such as a CPU, at least one network interface (704) a, user interface (703), a memory (705), at least one communication bus (702), and a display (706).

The communication bus (702) may complete a connection and communication among the above-mentioned components, and the user interface (703) may include a display and a keyboard. Optionally, the user interface (703) may also include a standard wired interface and wireless interface. The network interface (704) optionally may include a standard wired interface and wireless interface, for example, a WIFI interface. The memory (705) may be high-speed RAM or nonvolatile memory, for example, at least one disk storage module. The memory (705) may optionally be a storage device far away from the processor (701). As shown in FIG. 7, the memory (705) may be a computer storage medium, which may store an operating system, network communication module, user interface module, and application client program.

As shown in FIG. 7, the user terminal (700), the network interface (704) is mainly used for connecting to the application server for data communication. The processor (701) may be used to invoke the application client program stored in the memory (705) and execute the following operations: receiving the prompt message sent by the application server by using the network interface (704), wherein the prompt message is used to prompt the user of the application client to input the default verification information; sending the default verification information input by the user in response to the prompt message to the application server by using the network interface (704), so that the application server may store the default verification information which is associated with the login account of the application client.

When the application server detects an occurrence of a default security risk event on the application client, the network interface (704) may be used to receive from the application server the default verification information which is associated with the login account of the application client, such that the application server may verify the application client.

In an embodiment, the processor (701) may invoke the application client program stored in the memory (705), and implements the following operations: the display 706 displays the prompt message.

Depending on an input mode selected by the application client, obtaining by the application client the default verification information input by the user utilizing a corresponding user interface (703) provided by the terminal (700) on which the application client is installed, wherein the input mode includes an input via anyone of the following: text character, sketching pad, voice, image, pictures or video.

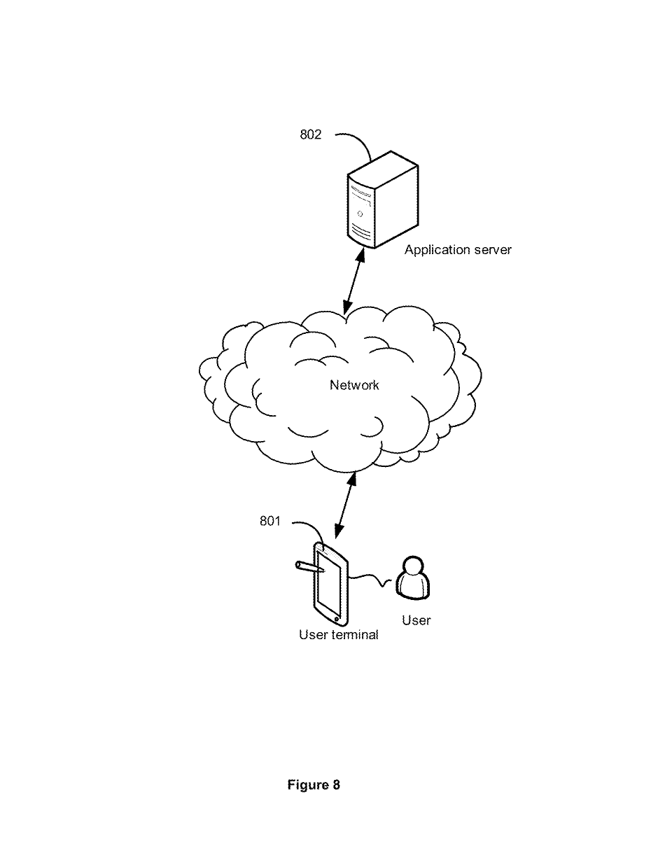

FIG. 8 illustrates an exemplary application security verification system, according to an embodiment of the present disclosure. The secure payment system may include a user terminal (801) and an application server (802). The user terminal (801) may be connected to the application server (802) through a network. The user terminal (801) may be a user terminal described above as shown in FIG. 7, which runs the application client described above as shown in FIG. 6. The application server (802) may be the application server described above as shown in FIG. 4 or FIG. 5.

The application server (802) is used to send a prompt message to the application client (801), wherein the prompt message is used to prompt the user of the application client to input the default verification information (801).

The application client (801) is used to receive a prompt message sent by the application server (802) and send to the application server (802) the default verification information input by the user in response to the prompt message.

The application server (802) may further be used to receive the default verification information sent by the application client (801) and store the default verification information which is associated with the login account of the application client (801).

The application server (802) may further be used to obtain, upon detecting the occurrence of a default security risk event on the application client (801). The default verification information is associated with the login account of the application client (801) and the default verification information is sent to the application client (801). The security risk event may be a login event, a payment event, or a verification information modification event.

The application client (801) may further be used to receive the default verification information sent by the application server (802), and the default verification information is used to verify the application client (801). In the embodiments of the present disclosure, the application server, on detecting the occurrence of a security risk event on the application client, sends to the application client the default verification information associated with the login account of the application client.

Accordingly, the user of the application client may verify the security of the application client and that of the application server, thereby effectively preventing any forged and illegal application from threatening the security of the user's private information and financial information.

The various embodiments described enable the user to prevent a “forged application client” from posing as a legitimate source to “phish” user's private information through the user taking a proactive action to “quiz” or “verify” the application client (which may pose as an alleged bank website or an alleged bank email notification to the user) through one or more default verification information (i.e., questions, passwords, voice, picture, video clip) which has previously been set up by the user and stored in the application server for verification purposes.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory.

The foregoing represents only some preferred embodiments of the present disclosure and their disclosure may not be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. An application security verification method, comprising:
detecting by an application server, an occurrence of a default security risk event on an application client;
obtaining by the application server, default verification information associated with a login account of the application client; and
sending by the application server, the default verification information to the application client in order to verify the application client.

2. The application security verification method according to claim 1, wherein, prior to the application server detecting the occurrence of the default security risk event on the application client, the method further comprising:
sending by the application server, a prompt message to the application client, wherein the prompt message is used to prompt a user of the application client to input the default verification information;
receiving by the application server, the default verification information sent by the application client in response to the prompt message;
the application server stores the default verification information in association with the login account of the application client.

3. The application security verification method according to claim 1, wherein the default security risk event comprises at least one of: a login event, a payment event, or a verification information modification event.

4. The application security verification method according to claim 1, wherein the default verification information comprises at least one of: text information, image information, audio information, or video information.

5. An application security verification method, comprising:
receiving by an application client, a prompt message sent by an application server, wherein the prompt message is used to prompt a user of the application client to input default verification information;
sending by the application client to the application server, the default verification information input by the user in response to the prompt message, such that the application server storing the default verification information in association with the login account of the application client; and
upon the application server detecting the occurrence of a default security risk event on the application client, the application client receiving from the application server the default verification information associated with the login account of the application client in order to verify the application client.

6. The application security verification method according to claim 5, wherein, after the application client receiving the prompt message sent by the application server, the method further comprising:
displaying the prompt message on the application client;
depending on an input mode selected by the application client, obtaining by the application client the default verification information input by the user utilizing a corresponding user interface provided by the terminal on which the application client is installed, wherein the input mode comprises an input via anyone of the following: text character, sketching pad, voice, image, pictures or video.

7. The application security verification method according to claim 5, wherein the default security risk event comprises anyone of: a login event, a payment event, or a verification information modification event.

8. A non-transitory computer readable storage medium, wherein the computer readable storage medium stores a program which comprises codes or instructions to cause a machine to execute application security verification operations, the operations comprising:
detecting by an application server, an occurrence of a default security risk event on an application client;
obtaining by the application server, default verification information associated with a login account of the application client; and
sending by the application server, the default verification information to the application client in order to verify the application client.

9. The non-transitory computer readable storage medium according to claim 8, wherein, prior to the application server detecting the occurrence of the default security risk event on the application client, the method further comprising:
sending by the application server, a prompt message to the application client, wherein the prompt message is used to prompt a user of the application client to input the default verification information;
receiving by the application server, the default verification information sent by the application client in response to the prompt message; and
the application server stores the default verification information in association with the login account of the application client.

10. The non-transitory computer readable storage medium according to claim 8, wherein the default security risk event comprises at least one of: a login event, a payment event, or a verification information modification event.

11. The non-transitory computer readable storage medium according to claim 8, wherein the default verification information comprises at least one of: text information, image information, audio information, or video information.

12. A non-transitory computer readable storage medium, wherein the computer readable storage medium stores a program which comprises codes or instructions to cause a machine to execute application security verification operations, the operations comprising:
receiving by an application client, a prompt message sent by an application server, wherein the prompt message is used to prompt a user of the application client to input default verification information;
sending by the application client to the application server, the default verification information input by the user in response to the prompt message, such that the application server storing the default verification information in association with the login account of the application client; and
upon the application server detecting the occurrence of a default security risk event on the application client, the application client receiving from the application server the default verification information associated with the login account of the application client in order to verify the application client.

13. The non-transitory computer readable storage medium according to claim 12, wherein, after the application client receiving the prompt message sent by the application server, the method further comprising:
displaying the prompt message on the application client;
depending on an input mode selected by the application client, obtaining by the application client the default verification information input by the user utilizing a corresponding user interface provided by the terminal on which the application client is installed, wherein the input mode comprises an input via anyone of the following: text character, sketching pad, voice, image, pictures or video.

14. The non-transitory computer readable storage medium according to claim 12, wherein the default security risk event may be anyone of: a login event, a payment event, or a verification information modification event.

15. An application server, wherein the application server comprises at least a processor operating in conjunction with at least a memory which stores instruction codes operable to perform functions as plurality of units, wherein the plurality of units comprise:
a security event detection unit, which causes the server to detect an occurrence of a default security risk event on an application client;
a verification information acquisition unit, which causes the server to obtain default verification information associated with the login account of the application client when the security event detection unit detects an occurrence of a default security risk event on the application client; and
a sending unit, which causes the server to send the default verification information to the application client in order to verify the application client.

16. The application server according to claim 15, wherein
the sending unit further causes the server to send a prompt message to the application client, wherein the prompt message is used to prompt the user of the application client to input the default verification information;
the application server further comprises:
a receiving unit, which causes the server to receive the default verification information sent by the application client in response to the prompt message;
a verification information storage unit, which causes the server to store the default verification information in association with the login account of the application client.

17. The application server according to claim 15, wherein the security risk event comprises at least one of: a login event, a payment event, or a verification information modification event.

18. The application server according to claim 15, wherein the default verification information comprises at least one of: text information, image information, audio information, or video information.

19. An application client, comprises at least a processor operating in conjunction with at least a memory which stores instruction codes operable to perform functions as plurality of units, wherein the plurality of units comprise:
a receiving unit, which causes the server to receive a prompt message sent by an application server, wherein the prompt message is used to prompt a user of the application client to input the default verification information;
a sending unit, which causes the server to send to the application server the default verification information which is input by the user in response to the prompt message, such that the application server stores the default verification information which is associated with the login account of the application client; and
the sending unit further causes the server to receive from the application server, the default verification information associated with the login account of the application client to verify the application client when the application server detects an occurrence of a default security risk event on the application client.

20. The application client according to claim 19, wherein the application client further comprises:
a display unit, which displays the prompt message;
a user interface unit, which, depending on an input mode selected by the application client, obtains the user-input default verification information utilizing a corresponding user interface provided by the terminal on which the application client is installed, wherein the input mode comprises an input via anyone of the following: text character, sketching pad, voice, image, pictures or video.

21. The application client according to claim 19, wherein the security risk event comprises anyone of: a login event, a payment event, or a verification information modification event.

22. An application security verification system, wherein the application security verification system comprises at least an application client and an application server, wherein:
The application server sends a prompt message to the application client, wherein the prompt message is used to prompt a user of the application client to input default verification information;
the application client receives a prompt message sent by an application server and sends to the application server the default verification information input by a user in response to the prompt message;
wherein the application server receives the default verification information sent by the application client and store the default verification information which is associated with the login account of the application client;
the application server further detects an occurrence of a default security risk event on the application client, obtains the default verification information associated with the login account of the application client and sends the default verification information to the application client; and
wherein the application client receives the default verification information sent by the application server, wherein the default verification information is used to verify the application client.

23. The application security verification system according to claim 22, wherein the security risk event comprises at least one of: a login event, a payment event, or a verification information modification event.
